(19) United States
(12) Patent Application Publication
(10) Pub. No.: US 2017/0126057 A1
(43) Pub. Date: May 4, 2017

(54) GENERATOR HAVING IMPROVED COLD WEATHER STARTING

(71) Applicant: Champion Engine Technology, LLC, Sussex, WI (US)

(72) Inventors: Leigh Jenison, Hartland, WI (US); James J. Dehn, Brookfield, WI (US); Mark J. Sarder, Waukesha, WI (US); Chris Despears, Menomonee Falls, WI (US)

(21) Appl. No.: 15/296,558

(22) Filed: Oct. 18, 2016

Related U.S. Application Data
(60) Provisional application No. 62/249,571, filed on Nov. 2, 2015.

(51) Int. Cl. H02J 9/08; H02J 7/14; F02N 11/08; F02B 63/04; F02M 21/02

(52) U.S. Cl. CPC H02J 9/08; F02B 63/04; F02M 21/0215; F02M 21/0212; F02N 11/0862; H02J 7/1415

(57) ABSTRACT

A generator includes an internal combustion engine operable on a gaseous fuel and an alternator driven by the engine to produce electrical power for distribution from the generator. The generator may also include a 24-volt starter motor to crank the engine, one or more batteries to provide electrical power to operate the starter motor, and a magneto driven by the engine to provide spark ignition of the gaseous fuel when starting the engine with the starter motor.

### CROSS-REFERENCE TO RELATED APPLICATION

The present application is a non-provisional of, and claims priority to, U.S. Provisional Patent Application Ser. No. 62/249,571, filed Nov. 2, 2015, the disclosure of which is incorporated herein by reference in its entirety.

### BACKGROUND OF THE INVENTION

Embodiments of the invention relate generally to standby generators and, more particularly, to a method and apparatus for improving cold weather starting of a standby generator.

Some standby generators are configured for automatic startup to supply backup power when utility power is interrupted. Standby generators are often started with a starter motor that cranks a prime mover of the generator, and the starter motor is often powered by a battery. Unfortunately, outdoor generators located in cold weather climates suffer increased cranking load on the battery during startup due to the cold temperatures. For instance, engine oil becomes more viscous at low temperature which increases engine friction acting against the starter motor. At the same time, cold temperatures can increase internal resistance in the battery and can lower battery capacity reducing power available to the starter motor. The capacity of some lead acid batteries decreases by 50% or more from rated capacity over temperature ranges in cold climates. Increased engine friction and reduced battery performance can reduce cranking speeds preventing generators from starting in cold weather.

Some manufacturers of standby generators offer retrofit kits for the generators aiming to improve cold weather operation. For instance, some manufacturers provide oil warmers attempting to increase the viscosity of engine oil so that the engine turns over easier. Battery heaters are also used striving to decrease internal resistance of the battery, and some battery heaters may comprise a heating pad placed under the battery. Unfortunately, supplying electricity to heaters can drain battery power or add considerably to electric bills, or may not be available. Some manufacturers provide wraps on the oil filter of the engine trying to protect the oil from cold ambient temperatures. Still, other manufacturers install choke systems to alter the air-fuel ratio upon starting. However, such devices are ineffective and proven unreliable for cold weather starting and also add unnecessary cost to the generator.

Therefore, it would be desirable to design a cost efficient apparatus and method to increase starting power delivered to a standby generator for improved cold weather starting.

### BRIEF DESCRIPTION OF THE INVENTION

In accordance with one apsect of the invention, a generator includes an internal combustion engine operable on a gaseous fuel and an alternator driven by the engine to produce electrical power for distribution from the generator. The generator may include a 24-volt starter motor to crank the engine and one or more batteries to provide electrical power to operate the starter motor. The engine can also drive a magneto to provide spark ignition of the gaseous fuel when starting the engine with the starter motor.

In accordance with another aspect of the invention, a standby generator includes an alternator to provide electricity to an electrical system of a building and an internal combustion engine operable on propane or natural gas to drive the alternator. The standby generator may include a 24-volt starter motor to crank the engine and a battery charger powered by the alternator to recharge the 24-volt battery system. The 24-volt battery system runs the starter motor upon interruption of utility power to the building and an automatic transfer switch engages electricity provided by the standby generator to the electrical system of the building.

In accordance with yet another aspect of the invention, a standby generator includes an internal combustion engine and an alternator operatively coupled to the internal combustion engine to provide electricity for distribution from the generator. The standby generator may also include an ignition magneto driven by the engine and a starter motor to crank the engine driving the ignition magneto to start the engine. The generator can also include at least two 12-volt batteries connected in series to power the starter motor.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a front, left side perspective view of a generator incorporating the present invention that is coupled to an electrical distribution panel of a building, according to an embodiment of the invention.

FIG. 2 is a similar illustration of FIG. 1 with the doors in an open position exposing a generator engine configured to operate with a magneto.

FIG. 3 is a front, left perspective view of the engine in the generator of FIG. 2 shown with an engine cover exploded off the engine to show a magneto.

FIG. 4 is a top perspective view of the generator of FIG. 1 in an alternate embodiment to that of FIG. 2 with the doors in an open position showing a generator and engine having a battery-coil operated ignition.

FIG. 5 is a performance chart showing starting sequence of a generator operated with a 12-volt battery system and a generator operated with a 24-volt battery system both at a temperature of −30 degrees Celsius.

### DETAILED DESCRIPTION OF THE PREFERRED EMBODIMENT

The operating environment of the invention is described with respect to a standby generator, typically used in homes or businesses. However, it will be appreciated by those skilled in the art that the invention is equally applicable for use with portable generators, or other engines operating in cold climates. The invention will be described with respect to a standby generator having an internal combustion engine operable on a gaseous fuel. However, one skilled in the art will further appreciate that the invention is equally applicable for use with respect to an internal combustion engine operable on other fuel sources.

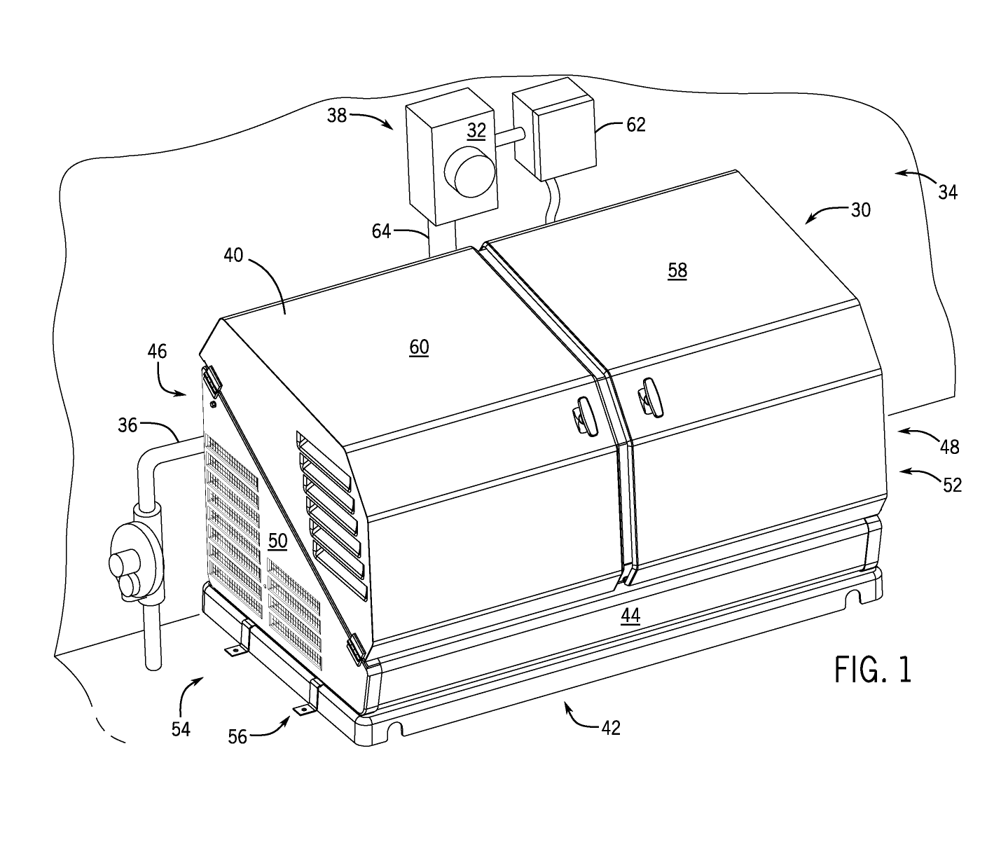

Referring to FIG. 1, a standby generator 30 coupled to an electrical distribution panel 32 of a building 34 is shown, in accordance with an embodiment of invention. Standby generator 30 is configured to provide a backup supply of electricity to building 34 in case power outages occur in the utility grid. Standby generator 30 has a prime mover internally that drives an alternator to produce electrical power. The prime mover may comprise an internal combustion engine having a crankshaft operatively coupled to a shaft of the alternator. The internal combustion engine preferably operates on propane or natural gas from a gas line 36 to drive the alternator and provide electricity to an electrical system 38 of building 34. The engine and alternator are referred to as an engine-generator set hereinafter.

In accordance with an exemplary embodiment of the invention, standby generator 30 has an enclosure 40 to provide protection against the elements and to insulate noise emanating from the generator. Enclosure 40 has a rectangular base 42 to support an engine-generator set. A front wall 44 and a back wall 46 extending vertically from base 42 along the length of enclosure 40. A first side wall 48 is located on the right side and a second side wall 50 is located on the left side extending vertically from base 42 at a respective first end 52 and second end 54 of enclosure 40. Together, base 42, first and second side walls 48, 50 and front and back walls 44, 46 form an enclosure frame 56. The enclosure 40 also has a first door 58 and a second door 60 that cover enclosure 40 when the doors are closed. In one embodiment of the invention, a generator 30 has an enclosure 40 comprising a frame assembly 56 and a pair of opposing, substantially symmetrical doors 58, 60 enclosing the frame assembly 56 on a top side of the generator.

The standby generator may also include an automatic transfer switch 62 that switches the power supply to building 34 from a utility electrical grid 64 to generator 30. Automatic transfer switch 62 initiates startup of generator 30 to engage a backup supply of electricity provided to electrical system 38 of building 34 upon sensing an interruption from the utility grid 64 to the building 34.

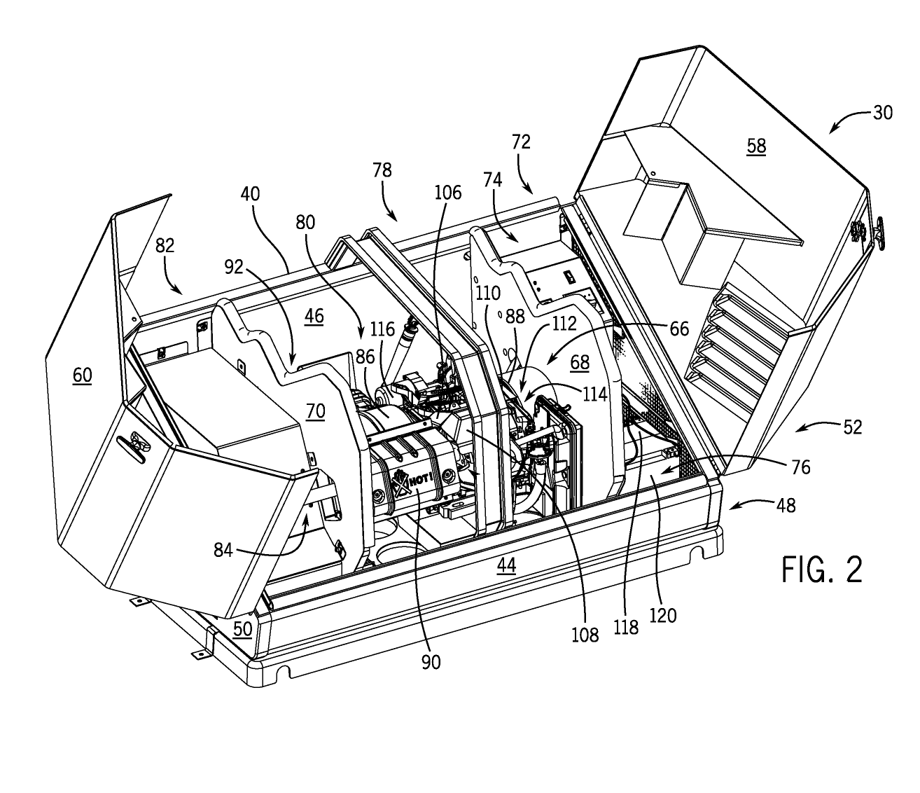

Referring to FIG. 2, standby generator 30 has first door 58 and second door 60 shown in an open position exposing an engine-generator set 80, in accordance with an embodiment of the invention. Standby generator 30 may be separated into three chambers by a first partition wall 68 and a second partition wall 70 that extend across enclosure 40 from front wall 44 to back wall 46. A control chamber 72 is located between first side wall 48 and first partition wall 68. Control chamber 72 houses an automatic control system 74 to operate generator 30, and a battery system 76 for starting engine 66, as well as other ancillary components. The battery system 76 can run a starter motor 116 to start generator 30 upon interruption of utility power to the building. Accordingly, control system 74 can automatically control operation of engine 66 and automatic transfer switch 62 of FIG. 1 to control engagement of electricity provided to the electrical system of the building. Referring back to FIG. 2, a power train chamber 78 is located between first partition wall 68 and second partition wall 70 to house engine-generator set 80 and related components. An exhaust chamber 82 is located between second partition wall 70 and second side wall 50. Exhaust chamber 82 houses components of an exhaust system 84 and other ancillary components and ejects exhaust to the environment.

The power train chamber 78 houses engine-generator set 80 which preferably includes an internal combustion engine 66 and an alternator 86 driven by the internal combustion engine. Internal combustion engine 66 may include one or more cylinders with each cylinder having a piston slidably positioned therein. Combustible fuel is provided to each cylinder through a respective intake valve that is then compressed and ignited causing reciprocal motion of the pistons. The reciprocal motion of the pistons is converted to rotational motion of a crankshaft. The crankshaft is coupled to an alternator shaft to drive alternator 86 and provide electrical energy for distribution from standby generator 30.

In an exemplary embodiment of the invention, engine-generator set 80 has a horizontal shaft arrangement and is positioned so that internal combustion engine 66 is located toward first end 52 of enclosure 40 from alternator 86. Engine fan 88 is driven by the crankshaft and faces control chamber 72. Engine fan 88 pulls air through first partition wall 68 to cool engine 66 and blows the air through a heat duct assembly 90 into exhaust chamber 82. Alternator 86 may have an exhaust fan 92 driven by the alternator shaft and located opposite internal combustion engine 66. Exhaust fan 92 pulls cooling air axially through alternator 86 and drives it into exhaust chamber 82 through an opening in second partition wall 70. In one embodiment of the invention, heat duct assembly 90 may direct cooling air expelled from engine 66 into exhaust chamber 82 so that it bypasses exhaust fan 92 to reduce fan size and power consumption.

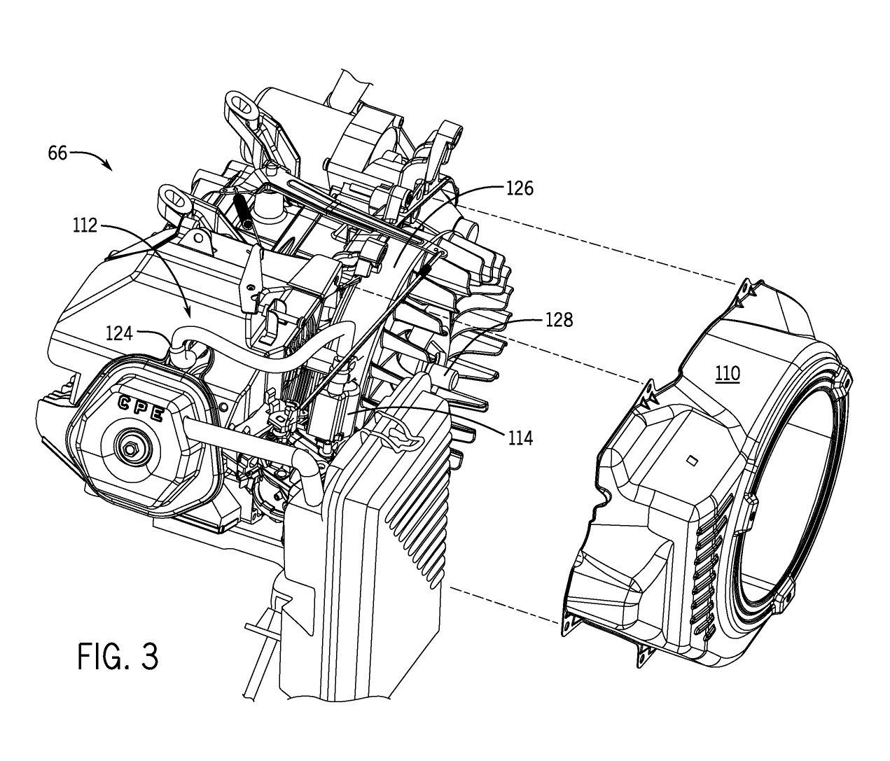

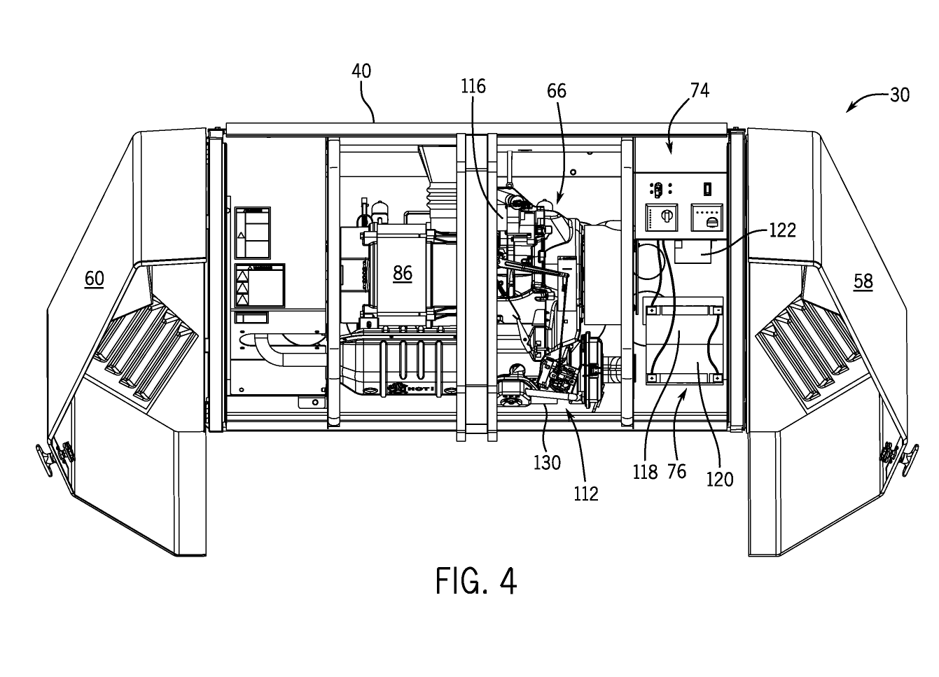

The standby generator 30 also includes an ignition system 112 located within engine covers 106, 108, 110. As will be further described with respect to FIGS. 3-4, ignition system 112 ignites a compressed air-fuel mixture in each cylinder that drives a corresponding piston coupled to a crankshaft of engine 66. Ignition system 112 includes a spark plug for each cylinder having two electrodes that form a spark plug gap. Referring back to FIG. 2, standby generator 30 may include a magneto 114 located under engine cover 110 and driven by engine 66 to power the spark plugs in the engine. Magneto 114 generates a high voltage that initiates current flow across the spark plug gap. An arc discharges between the electrodes creating the spark energy necessary to ignite the air-fuel mixture.

In an exemplary embodiment of the invention, generator 30 also includes a starter motor 116 to crank engine 66 and a battery system 76 to power the starter motor. In one embodiment of the invention, starter motor 116 operates on 24-volts and battery system 76 is configured to provide 24-volts to the starter motor. A 24-volt starter motor cranks the engine with increased torque and speed compared to a 12-volt starter motor. A higher voltage starter motor is preferred for cold weather applications where cold ambient temperatures increase the cranking load on the battery. As such, a higher voltage starter motor can deliver more torque and can crank engine 66 faster to increase the momentum of the engine during startup. A higher voltage starter motor also provides more cranking events per minute allowing engine 66 to fire quicker. An increased starting power also adds to the speed and momentum of engine 66 during start-up.

A generator having a higher voltage starter motor 116 is particularly desirable for cold weather startup. Engine oil becomes more viscous in cold temperatures and adds to rotational friction of engine 66. Further, cold temperatures contract moving parts that add to rotational friction within engine 66. A higher voltage starter motor provides more power to counteract the increased friction at low temperatures. In addition, some generators use an ignition system 112 having magneto 114 that generates voltage relative to engine speed, and therefore starter motor 116 drives engine 66 to power magneto 114 to start the engine. If cold weather causes cranking speed to be too low, magneto 114 will not produce enough voltage to produce a spark powerful enough to start the engine. Accordingly, magneto 114 will generate more ignition energy for easier startup when engine 66 is cranked at higher speed.

Increased ignition energy is beneficial to promote more complete combustion for more power and improved efficiency. A stronger spark from the spark plug creates a superior flame for better overall combustion chemistry and results in less unburned fuel in the exhaust. In addition, misfires can occur if insufficient energy is supplied to spark the combustion chamber. The voltage required to generate a spark across the spark plug gap is a function of fuel and temperature conditions, including fuel mixture and cylinder pressure. The availability of higher voltage from ignition system 112 provides more power to the spark plug and therefore a better chance at starting with less cranks. Further, the higher quality of a spark can ignite more fuel as the air-fuel mixture swirls across the spark in the cylinder and has more strength to ensure superior ignition of the fuel. As such, an ignition system providing higher voltage improves engine efficiency and power by releasing more energy from the fuel while reducing unburned fuel in the exhaust.

Increasing ignition energy from an ignition system 112 is particularly advantageous for operating a generator in cold weather. Gaseous fuels, for example propane or natural gas, can be harder to start in colder temperatures. Fuel source and tank pressures can decreases with temperature. Reduced fuel pressure can cause the air-fuel mixture to be excessively lean and can limit atomization of the fuel. Further, air becomes denser in cold temperatures which can also affect the air-fuel ratio and the flammability of the mixture. Poor combustion can result in decreased power available during startup.

In addition there is a minimum ignition energy that is required to ignite the compressed air-fuel mixture, which can change according to air-fuel composition and temperature. A decrease in the fuel pressure could result in a lean air-fuel mixture resulting in an increase in the minimum ignition energy required. Further, the minimum ignition energy required can increase as temperature decreases, and cold fuel and air may not heat enough upon compression for a weak spark to initiate combustion. Incomplete combustion or ignition misfires will occur if the minimum ignition energy is not delivered by the spark plug. Increased energy from ignition system 112 can increase spark duration and spark current to ensure delivery of a minimum ignition energy.

In one embodiment of the invention, starter motor 116 is geared to crank the engine at a rate of at least 500 rpm to start engine 66 when acclimated to an ambient temperature of −30 degrees Celsius (−22 degrees Fahrenheit). In another embodiment of the invention, starter motor 116 is a 24-volt starter motor that cranks the engine at a rate of at least 500 rpm at −30 degrees Celsius in contrast to a 12-volt starter motor that typically cranks the engine at approximately 250 rpm at the same temperature. In some applications, cranking speeds are increased from approximately 200 rpm with a 12-volt starter motor, to 500 rpm with a 24-volt starter motor. Moreover, a 24-volt starter motor may offer nearly instant starting in cold weather conditions higher than at −30 degrees Celsius as compared to 12-volt starting systems.

Still referring to FIG. 2, the generator 30 includes a battery system 76 to provide electrical power to operate starter motor 116. Battery system 76 may comprise a single 24-volt battery or first and second 12-volt batteries 118, 120 arranged in series to power a starter motor 116 that is configured to operate on 24-volts. Battery system 76 may include more than two 12-volt batteries connected in series to power a starter motor 116 configured to operate on more than 24 volts, including but not limited to 36 volts and 48 volts. Battery system 76 may include batteries of any voltage coupled in series, or include batteries of identical voltage coupled in parallel to increase capacity. In addition to a multi-battery configuration, a single battery could be used to deliver 24 volts, 36 volts, 48 volts, or any voltage to operate starter motor 116 rated for a corresponding voltage. Generator 30 may also include one or more battery chargers 122 (FIG. 4) powered by alternator 86 to recharge battery system 76, and the generator may include an electronic control system 74 operable on 24-volts or a similar voltage to that of the starting system to control automatic startup of engine 66.

Referring now to FIG. 3, an engine 66 for a generator configured to supply standby power to a home or building is shown with engine cover 110 exploded off the engine to show magneto 114, in accordance with an embodiment of the invention. Internal combustion engine 66 is operable on a gaseous fuel or a combination of gaseous and liquid fuels to drive an alternator and produce electrical power for distribution from the generator. The gaseous fuel may be at least one of propane and natural gas, and engine 66 could operate on both propane and natural gas. In other embodiments of the invention, the engine 66 operates on a liquid fuel, for instance gasoline or diesel, but could also operate on blended fuels including gaseous and liquid fuel blends. Magneto 114 can be driven by engine 66 to power a spark plug 124 for each cylinder providing spark ignition of the gaseous fuel when starting the engine with a starter motor.

The ignition magneto 114, or high tension magneto, generates current for ignition system 112. Magneto 114 produces pulses of high voltage delivered to spark plug 124 to ignite the compressed air-fuel mixture in a respective cylinder. Magneto 114 can include a primary and secondary coil wound on an iron core. Magneto 114 can also include magnets attached to flywheel 126 of engine 66. As crankshaft 128 turns, the magnets spin past the primary coil of magneto 114. The current generated in the primary coil is switched on and off by a set of contacts with a condenser to reduce contact arc wear. Each time the contacts open, voltage is induced in the secondary coil having many more turns than the primary coil multiplying the voltage into high voltage pulses required by spark plug 124. The contacts, also referred to as points, are activated by a lobe on the crankshaft to ensure proper ignition timing. Alternatively, electronic controls may be used instead of points. Magneto 114 can operate independently from a battery and is beneficial for its simple operation and reliability.

Referring now to FIG. 4, a top perspective view of a standby generator 30 with first and second doors 58, 60 in an open position exposes generator engine 66 having a battery-coil operated ignition 130, in accordance with an embodiment of the invention. Standby generator 30 includes an alternator 86 operatively coupled to internal combustion engine 66 to provide electricity for distribution from generator 30. Engine 66 is configured to operate on either or both of propane and natural gas and has a starter motor 116 that preferably operates on 24-volts. A battery system 76 operates starter motor 116 and may comprise two 12-volt batteries 118, 120 coupled in series. In one embodiment of the invention, the two 12-volt batteries 118, 120 power starter motor 116 to crank engine 66 to at least 500 rpm at −30 degrees Celsius. Standby generator 30 further includes a battery charger 122 which may be a 115V to 24V voltage converter powered by alternator 86 to recharge first and second 12-volt batteries 118, 120. Standby generator 30 may also include an electronic control system 74 configured to operate on a matching voltage to accommodate the voltage from series connected batteries 118, 120 to operate the generator.

In the embodiment shown in FIG. 4, standby generator 30 includes a battery-coil operated ignition 130 to power a spark plug for each respective cylinder to run the engine. The spark plug couples to a secondary winding of an ignition coil within the battery-coil operated ignition 130. The ignition coil also has a primary winding coupled to receive power from battery system 76. The ignition coil has a primary-side switch that closes so the primary winding can receive energy from battery system 76 and store the energy in the magnetic field of the ignition coil. The ignition coil also acts as a transformer so that the stored energy is provided to the spark plug as a high-voltage ignition pulse at the point of ignition.

In an exemplary embodiment of the invention, battery-coil operated ignition 130 is a 24-volt ignition powered from a corresponding voltage supplied from battery system 76. A battery system 76 with a higher voltage can provide more power to battery-coil operated ignition 130. A battery system 76 with a higher voltage operating ignition system 112 is particularly beneficial for cold temperature starting to account for increased cranking resistance. In addition, a higher voltage battery system 76 can provide higher ignition energy to more efficiently crank engine 66 during cold starting for improved combustion and reduced misfires resulting in increased power output. Accordingly, battery system 76 of the present invention is of a higher voltage than that of a traditional 12 volt system, and aside from a 24 volt system, may be 36 volts, 48 volts, etc. The voltage can be selected based on the aforementioned description to operate a battery-coil operated ignition 130 and a starter motor 116 as described herein.

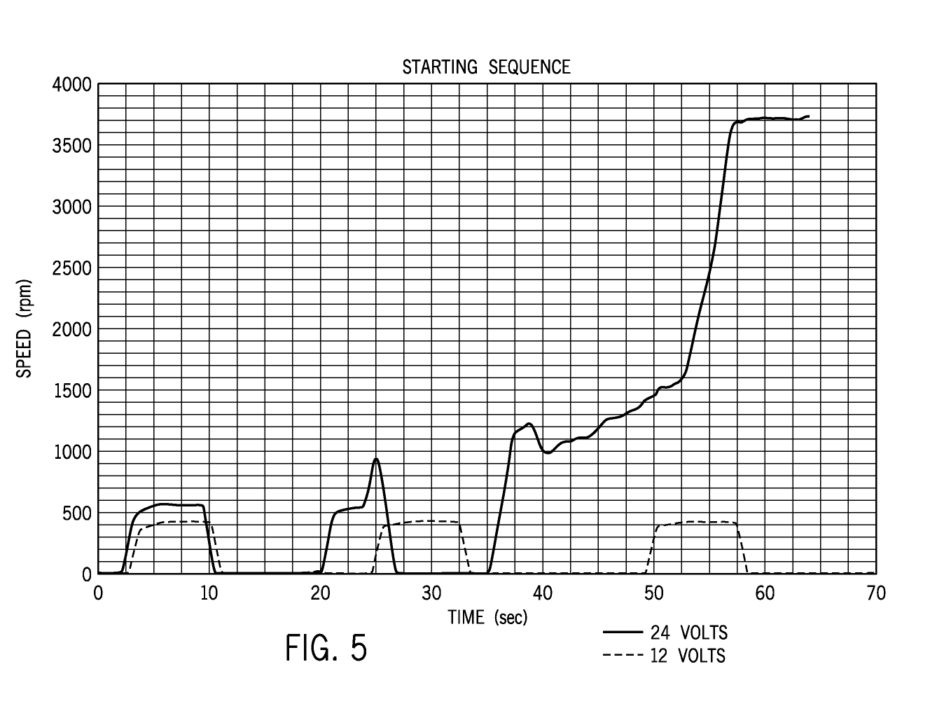

Referring now to FIG. 5, a performance chart shows a starting sequence of a generator unit operated with a 12-volt battery system against one with a 24-volt battery system, both at a temperature of −30 degrees Celsius, according to an embodiment of the invention. That is, starting attempts of standby generator 30 of FIG. 1 operated at −30 degrees Celsius are shown in the performance chart of FIG. 5. The 12-volt unit exhibited engine cranking speed of about 400 rpm while the 24-volt unit exhibited engine cranking speed of approximately 600 rpm. The 24-volt unit typically started in the third starting sequence whereas the 12-volt unit did not start after several starting sequences.

The 24-volt unit used a 24-volt starter motor to crank the engine. The 24-volt starter motor cranked the engine about 580 rpm during the cranking cycle. The starting sequence was initiated a second time and the cranking speed reached initially about 550 rpm for a period of time before the cranking speed increased to about 950 rpm before powering down. The starting sequence was initiated a third time and the cranking speed increased linearly from 0 rpm to about 1150 rpm, followed by increases in speed to about 1600 rpm, and then climbing substantially linearly to an operating speed of about 3700 rpm. As shown in the graphs, the 24-volt starter motor can be configured to crank the engine at least 500 rpm to start the engine when acclimated to an ambient temperature of −30 degrees Celsius.

In contrast, the 12-volt unit used a 12 volt starter motor to crank the engine. The 12-volt starter motor cranked the engine to a maximum of about 400 rpm but failed to start the engine after several attempts at the starting sequence. In addition, the starting sequence for the 24-volt unit could be repeated with a shorter break between cycles as compared to the 12-volt unit.

The first starting sequence for both the 12-volt and 24-volt units show that the 24-volt unit had a higher total number of cranking events at peak cranking speed for the respective units. The 24-volt unit exhibited a peak cranking speed of about 600 rpms for about 4 seconds and the 12-volt unit exhibited a peak cranking speed of about 400 rpm for about the same amount of time. As such, the peak cranking speed was about 200 rpm higher for the 24-volt unit with a corresponding higher total number of cranking events at peak cranking speed, and more cranks provide more power to the engine for startup.

Beneficially, embodiments of the invention thus provide a standby generator having increased starting power. In addition, embodiments of the invention provide for increased ignition energy upon starting a standby generator. Embodiments of the invention further provide for a starter motor having increased voltage for cold starting an engine. Embodiments of the invention also provide for an improved multi-battery generator that provides more reliable starting in cold weather and at low cost.

Therefore, according to one embodiment of the invention, a generator includes an internal combustion engine operable on a gaseous fuel and an alternator driven by the engine to produce electrical power for distribution from the generator. The generator may also include a 24-volt starter motor to crank the engine, one or more batteries to provide electrical power to operate the starter motor, and a magneto driven by the engine to provide spark ignition of the gaseous fuel when starting the engine with the starter motor.

According to another embodiment of the invention, a standby generator includes an alternator to provide electricity to an electrical system of a building, an internal combustion engine operable on propane or natural gas to drive the alternator, and an automatic transfer switch to engage the providing of electricity to the electrical system upon interruption of utility power to the building. The standby generator may also include a 24-volt starter motor to crank the engine, a 24-volt battery system to run the starter motor upon the interruption of the utility power to the building, and a battery charger to recharge the 24-volt battery system.

According to yet another embodiment of the invention, a standby generator includes an internal combustion engine and an alternator operatively coupled to the internal combustion engine to provide electricity for distribution from the generator. The standby generator may also include an ignition magneto driven by the engine and a starter motor to crank the engine driving the ignition magneto to start the engine. The generator can also include at least two 12-volt batteries connected in series to power the starter motor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A generator comprising:
an internal combustion engine operable on a gaseous fuel;
an alternator driven by the engine to produce electrical power for distribution from the generator;
a 24-volt starter motor to crank the engine;
one or more batteries to provide electrical power to operate the starter motor; and
a magneto driven by the engine to provide spark ignition of the gaseous fuel when starting the engine with the starter motor.

2. The generator of claim 1 wherein the starter motor is geared to crank the engine at least 500 rpm to start the engine with an ambient temperature of −30 degrees Celsius.

3. The generator of claim 1 wherein the one or more batteries are arranged to provide 24-volts to the starter motor.

4. The generator of claim 1 wherein the one or more batteries comprises two 12-volt batteries coupled in series to power the 24-volt starter motor.

5. The generator of claim 1 further comprising one or more battery chargers powered by the alternator to recharge the one or more batteries.

6. The generator of claim 1 further comprising an electronic control system operable on 24-volts to operate the generator.

7. The generator of claim 1 wherein the gaseous fuel is at least one of propane and natural gas.

8. The generator of claim 1 wherein the generator is configured to supply standby power to a home or building.

9. A standby generator comprising:
an alternator to provide electricity to an electrical system of a building;
an internal combustion engine operable on propane or natural gas to drive the alternator;
an automatic transfer switch to engage the providing of electricity to the electrical system upon interruption of utility power to the building;
a 24-volt starter motor to crank the engine;
a 24-volt battery system to run the starter motor upon the interruption of the utility power to the building; and
a battery charger to recharge the 24-volt battery system.

10. The standby generator of claim 9 wherein the 24-volt starter motor is configured to crank the engine at least 500 rpm to start the engine in an ambient temperature of −30 degrees Celsius.

11. The standby generator of claim 9 wherein the 24-volt battery system comprises two 12-volt batteries coupled in series.

12. The standby generator of claim 9 further comprising a magneto driven by the engine to power one or more spark plugs in the engine.

13. The standby generator of claim 9 further comprising a battery and coil-operated ignition to run the engine.

14. The standby generator of claim 10, further comprising an electronic control system configured to operate on 24-volts to operate the generator.

15. A standby generator comprising:
an internal combustion engine;
an alternator operatively coupled to the internal combustion engine to provide electricity for distribution from the generator;
an ignition magneto driven by the engine;
a starter motor to crank the engine driving the ignition magneto to start the engine; and
at least two 12-volt batteries connected in series to power the starter motor.

16. The standby generator of claim 15 wherein the starter motor is a 24-volt starter motor.

17. The standby generator of claim 15 further comprising a 115V to 24V voltage converter powered by the alternator to recharge the at least two 12-volt batteries.

18. The standby generator of claim 15 wherein the at least two 12-volt batteries power the starter motor to crank the engine to at least 500 rpm at −30 degrees Celsius.

19. The standby generator of claim 15 wherein the engine is configured to operate on both propane and natural gas.

20. The generator of claim 1 further comprising an automatic engine controller to operate the engine.

21. The standby generator of claim 9 further comprising an automatic engine controller to operate the engine.

22. The standby generator of claim 9 further comprising an automatic transfer switch controller to control engagement of electricity provided to the electrical system of the building.

23. The standby generator of claim 15 further comprising an automatic controller operable on 24-volts to operate the engine.
